(19) United States
(12) Patent Application Publication
(10) Pub. No.: US 2023/0078284 A1
(43) Pub. Date: Mar. 16, 2023

(54) METHOD AND SYSTEM FOR EXECUTING A PROBABILISTIC PROGRAM

(71) Applicant: SAMSUNG ELECTRONICS CO., LTD., Suwon-si (KR)

(72) Inventors: Efthymia TSAMOURA, Chertsey (GB); Jaehun LEE, Chertsey (GB); Timothy HOSPEDALES, Chertsey (GB)

(73) Assignee: SAMSUNG ELECTRONICS CO., LTD., Suwon-si (KR)

(21) Appl. No.: 17/944,843

(22) Filed: Sep. 14, 2022

(30) Foreign Application Priority Data
Sep. 15, 2021 (GR) 20210100606
Sep. 23, 2021 (GB) 2113574.4

(51) Int. Cl. G06N 7/00; G06N 5/02

(52) U.S. Cl. CPC G06N 7/005; G06N 5/022

(57) ABSTRACT

Broadly speaking, the present techniques relate to methods and systems for executing a probabilistic program based on an uncertain knowledge base (KB). The methods and systems construct a trigger graph from the uncertain KB, each node of the trigger graph being associated with a rule of the uncertain KB.

### CROSS-REFERENCE TO RELATED APPLICATIONS

This application claims priority to Greek Patent Application No. 20210100606, filed on Sep. 15, 2021, in the Greek Patent Office and United Kingdom Patent Application No. 2113574.4, filed on Sep. 23, 2021, in the United Kingdom Patent Office, the disclosures of which are incorporated by reference herein in their entireties.

### BACKGROUND

### 1. Field

The present application relates to a method and system for executing a probabilistic program.

### 2. Description of Related Art

Blending logic with uncertainty has a long tradition in artificial intelligence (AI) and databases. One way of integrating logic with uncertainty is via probabilistic programming, which provides a means to represent relationships between different entities, and to associate those relationships with probability measures.

The adoption of probabilistic programming has increased in recent years, finding utility in applications such as semi-supervised learning, visual question answering (visual QA), activity detection and smart assistants. Despite this, probabilistic programming has not been widely adopted in practice. This is because existing techniques are not efficient in terms of runtime and memory, and because they are not expressive enough because they support only restricted classes of rules.

This disclosure provides a method for executing a probabilistic program that addresses the above-mentioned problems, and any other problems that would be apparent to the skilled reader from the description herein.

### SUMMARY

In a first approach of the present techniques, there is provided a computer-implemented method for executing a probabilistic program comprising: receiving an uncertain knowledge base, the uncertain knowledge base comprising a plurality of probabilistic facts, each probabilistic fact having an associated probability; receiving a plurality of rules, the plurality of rules for deriving new facts from the plurality of probabilistic facts; generating a trigger graph from the uncertain knowledge base, wherein each node of the trigger graph is associated with a rule of the plurality of rules, and wherein each node of the trigger graph stores a derivation history of the node; and computing probabilities of derived new facts using the derivation histories stored in the trigger graph.

The trigger graph may be generated incrementally. In a round k of generating the trigger graph, a trigger graph of depth k is constructed by adding nodes to a trigger graph of round k-1. The rules associated with the nodes present in the trigger graph at depth k may be executed. The derivation history of the knowledge in the trigger graph at depth k is stored.

The uncertain knowledge base may be a graph knowledge base, wherein the probabilistic facts are relationships represented by edges linking nodes representing entities, and the associated probability is a weight of an edge.

A probabilistic fact of the probabilistic facts may comprise a likelihood that a first person detected in an image is carrying out an activity. The rules may comprise rules for determining whether a second person detected in an image is also carrying out the activity. The derived new facts may include the likelihood that the second person detected in the image is also carrying out the activity. Accordingly, the method may be a computer-implemented method of group activity detection from images.

A probabilistic fact of the probabilistic facts may comprise a likelihood that a first object detected in an image has a first label. The rules may comprise rules for determining that a second object detected in the image has a second label. The second object may be a sub-object of the first object. The derived new facts may include the likelihood that the second object has the second label. The image including the first and second objects and first and second labels may be used to train a machine learning system. Accordingly, the method may be a computer-implemented method of generating training data in a semi-supervised machine learning system.

The method may comprise receiving a user query, and providing an answer to the query based on the derived new facts. Accordingly, the method may be a computer-implemented question answering method. The user query and the answer may relate to an input image.

The method may comprise selecting a part of the uncertain knowledge base relevant to the user query, and generating the trigger graph based on the selected part of the uncertain knowledge base.

The rules may relate to phenotypes. The probabilistic facts may relate to phenotypes. The method may be a computer-implemented method of phenotypic matching, uncovering latent phenotypes or semi-supervised phenotyping.

The probabilistic facts may be sensor data, suitably sensor data measuring characteristics of a user. The rules may relate to health recommendations. Accordingly, the method may be a computer-implemented method of providing healthcare recommendations.

In a related approach of the present techniques, there is provided a non-transitory data carrier carrying processor control code to implement the methods described herein.

In a second approach of the present techniques, there is provided a system for executing a probabilistic program, comprising: a memory configured to store: an uncertain knowledge base, the uncertain knowledge base comprising a plurality of probabilistic facts, each probabilistic fact having an associated probability, and a plurality of rules, the plurality of rules for deriving new facts from the plurality of probabilistic facts; and a processor coupled to the memory and arranged to: generate a trigger graph from the uncertain knowledge base, wherein each node of the trigger graph is associated with a rule of the plurality of rules, and wherein each node of the trigger graph stores a derivation history of the node; and compute probabilities of derived new facts using the derivation histories stored in the trigger graph.

Additional optional features of the second approach are as defined above in relation to the first approach, and may be combined in any combination.

As will be appreciated by one skilled in the art, the present techniques may be embodied as a system, method or computer program product. Accordingly, present techniques may take the form of an entirely hardware embodiment, an entirely software embodiment, or an embodiment combining software and hardware aspects.

Furthermore, the present techniques may take the form of a computer program product embodied in a computer readable medium having computer readable program code embodied thereon. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object oriented programming languages and conventional procedural programming languages. Code components may be embodied as procedures, methods or the like, and may comprise subcomponents which may take the form of instructions or sequences of instructions at any of the levels of abstraction, from the direct machine instructions of a native instruction set to high-level compiled or interpreted language constructs.

Embodiments of the present techniques also provide a non-transitory data carrier carrying code which, when implemented on a processor, causes the processor to carry out any of the methods described herein.

The techniques further provide processor control code to implement the above-described methods, for example on a general purpose computer system or on a digital signal processor (DSP). The techniques also provide a carrier carrying processor control code to, when running, implement any of the above methods, in particular on a non-transitory data carrier. The code may be provided on a carrier such as a disk, a microprocessor, CD- or DVD-ROM, programmed memory such as non-volatile memory (e.g. Flash) or read-only memory (firmware), or on a data carrier such as an optical or electrical signal carrier. Code (and/or data) to implement embodiments of the techniques described herein may comprise source, object or executable code in a conventional programming language (interpreted or compiled) such as Python, C, or assembly code, code for setting up or controlling an ASIC (Application Specific Integrated Circuit) or FPGA (Field Programmable Gate Array), or code for a hardware description language such as Verilog (RTM) or VHDL (Very high speed integrated circuit Hardware Description Language). As the skilled person will appreciate, such code and/or data may be distributed between a plurality of coupled components in communication with one another. The techniques may comprise a controller which includes a microprocessor, working memory and program memory coupled to one or more of the components of the system.

It will also be clear to one of skill in the art that all or part of a logical method according to embodiments of the present techniques may suitably be embodied in a logic apparatus comprising logic elements to perform the steps of the above-described methods, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

In an embodiment, the present techniques may be realised in the form of a data carrier having functional data thereon, said functional data comprising functional computer data structures to, when loaded into a computer system or network and operated upon thereby, enable said computer system to perform all the steps of the above-described method.

### BRIEF DESCRIPTION OF THE DRAWINGS

Implementations of the present techniques will now be described, by way of example only, with reference to the accompanying drawings, in which:

FIG. 1 is a schematic outline diagram of an example system for executing a probabilistic program;

FIG. 2 is a schematic diagram of an example system for executing a probabilistic program;

FIG. 3 is a schematic diagram of an uncertain knowledge base and a set of rules for deriving new facts from the facts in the uncertain knowledge base;

FIG. 4 is a schematic diagram illustrating a trigger graph generated from the uncertain knowledge base and set of rules of FIG. 3;

FIG. 5 is a schematic diagram illustrating the generation of the trigger graph of FIG. 4;

FIGS. 6A-6D are charts comparing performance of the present techniques with prior art techniques;

FIG. 7 is a schematic diagram illustrating application of the present techniques to group activity detection;

FIG. 8 is a schematic diagram illustrating application of the present techniques to semi-supervised learning;

FIG. 9 is an example partially-labelled image;

FIG. 10 is a schematic diagram illustrating application of the present techniques to visual question answering;

FIG. 11 is a schematic flowchart of an example method of executing a probabilistic program;

FIG. 12 is a schematic diagram illustrating application of the present techniques to phenotyping, and

FIG. 13 is a schematic diagram illustrating application of the present techniques to healthcare.

### DETAILED DESCRIPTION

Broadly speaking, the present techniques relate to methods and systems for executing a probabilistic program based on an uncertain knowledge base (KB). The methods and systems construct a trigger graph from the uncertain KB, each node of the trigger graph being associated with a rule of the uncertain KB. The trigger graph is then used to generate derivation trees, upon which the probabilistic program is executed. In some examples, the probabilistic program is, or forms part of, a user query. In other examples, the probabilistic program forms part of a semi-supervised learning system.

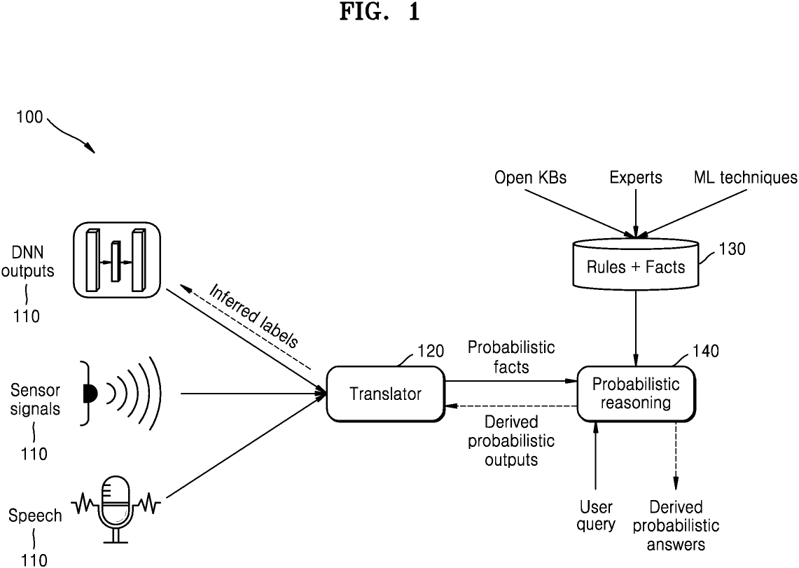

FIG. 1 shows a schematic outline of an example system 100 for executing a probabilistic program. Probabilistic logic programming, or simply, probabilistic programming, provides the means to concisely represent relationships between different entities, and to associate those relationships with probability measures. A probabilistic programming formalism consists of two components: a logical theory for representing relationships; and a mechanism for propagating uncertainty when performing inferences over the theory. A logical theory is a set of rules, which can be interpreted as if-then statements and show how to derive new knowledge, and a set of facts which represent background knowledge. References herein to executing a probabilistic program are references to carrying out a process or technique that derives new knowledge.

In the example system, components 110 (e.g., deep networks, or sensors) output observations (e.g., objects shown in an image, or an event). The observations are then translated into probabilistic facts by translator 120. Rules 130 are also provided, encoding domain specific knowledge (e.g. provided either by experts or via ML or available in commonsense sources). The system uses probabilistic reasoning 140 to then derive new facts given the translated probabilistic facts and rules 130. The new facts are either returned to the end application, e.g., in a query answering scenario, or used for training purposes, e.g., training deep networks with new labelled data.

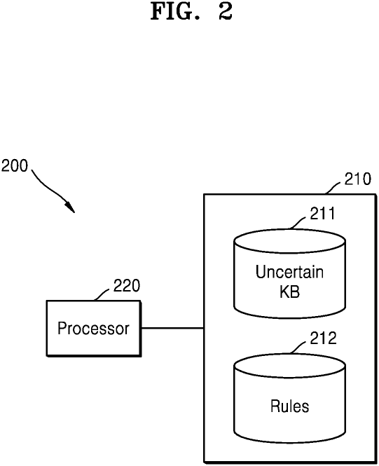

FIG. 2 shows an example system 200 for executing a probabilistic program. The example system 200 may form part or all of the example system 100. The system 200 The system comprises a memory 210, and a processor 220.

The memory 210 stores an uncertain knowledge base (KB) 211. The uncertain KB 211 may also be referred to as a probabilistic database or probabilistic KB. The uncertain KB stores a plurality of probabilistic facts, wherein each probabilistic fact has an associated probability. The associated probability reflects the likelihood of the probabilistic fact being true. Each fact may be represented in symbolic form, for example in first-order logic. The uncertain KB 211 may also be a graph KB or database, wherein the facts are relationships represented by edges linking nodes representing entities. The associated probability in this example may take the form of a weight of an edge.

The facts stored in the uncertain KB 211 may be derived from one or more of a wide range of sources. For example, the facts may be mined from unstructured or semi-structured data sources, for example using a machine learning system such as a deep neural network (DNN). In this case, the probability may be a confidence associated with a prediction made by the machine learning system. In other examples, the facts are classification results, for example the result of an image object detection or classification system. In such an example, the probability is a confidence associated with the object detection or classification. In further examples, the facts may be sensor outputs with associated confidences, or the output of a speech-to-text system with associated confidences as to the accuracy of the prediction.

The memory 210 also stores a plurality of rules 212, for example in a database or other suitable data structure. The plurality of rules 212 encode knowledge that allows the derivation of new facts from the facts stored in the uncertain KB 211, as will be discussed in more detail below. The rules 212 also may be derived from one or more of a wide range of sources. For example, the rules 212 may be provided by experts, derived by machine learning or obtained from a common sense knowledge source, such as ConceptNet. ConceptNet is discussed in Robyn Speer, Joshua Chin, and Catherine Havasi. 2017. “ConceptNet 5.5: An Open Multilingual Graph of General Knowledge” In proceedings of AAAI 31., the contents of which are incorporated herein by reference. Like the facts, the rules 212 may also be represented symbolically, for example in first-order logic.

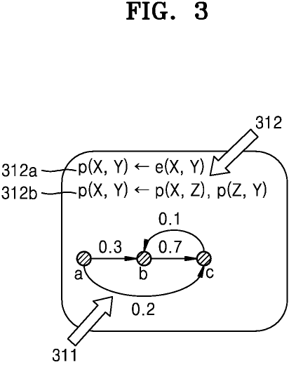

The processor 220 is configured to generate a trigger graph from the uncertain KB 211 and the rules 212, as will be discussed in more detail below with reference to FIGS. 3-5.

FIG. 3 illustrates an example set of rules 312 and uncertain KB 311. It will be understood that the example of FIG. 3 is greatly simplified to illustrate the present techniques, and in practice an uncertain KB 211 may comprise millions of facts, and thousands of rules 212.

In the example of FIG. 3, the uncertain KB 311 takes the form of a graph KB, with 3 nodes a, b, c. The data in the uncertain KB 311 indicates that there are edges from a to b (with probability 0.3), from b to c (with probability 0.7), from a to c (with probability 0.2), and from c to b (with probability 0.1).

The rules 312 comprise a first rule 312a and a second rule 312b. Rule 312a states that there is a path p from a node X to a node Y if there is an edge e from X to Y. Rule 312b states that there is a path p from X to Y if there is a path from X to Z and a path from Z to Y.

In order to compute the probability of a path between a and b, it is necessary to compute all the possible ways to derive the knowledge of the path. For example, in FIG. 3, it is necessary to compute the probability of a -> b in line with the first rule 312a and the probability of a -> c and c -> b in line with the first rule 312b.

Existing techniques to compute all different derivations of the knowledge may not be efficient. For example, some existing techniques execute the rules in a backwards fashion. In the example of FIG. 3, this would involve starting at b and working backwards to identify all possible paths leading back to a. This is inefficient because backward reasoning cannot perform rule executions using bulk processing of data. In other existing techniques, the rules are executed in a forward fashion. However, existing techniques introduces many new auxiliary rules, which slows the processing down and increases memory usage because more data is derived. These techniques may disadvantageously have no straightforward termination condition, and may effectively result in the construction of a more complex knowledge base to reason over. In order to address these issues, the disclosure provides techniques for deriving knowledge from the uncertain KB 211, which may reduce execution time and memory consumption.

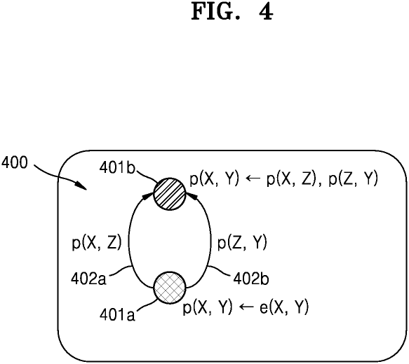

FIG. 4 illustrates a trigger graph 400, generated from the uncertain knowledge base 311 shown in FIG. 3 by processor 220. The trigger graph 400 is an acyclic directed graph that captures all the operations that need to be performed to compute the probabilities of the newly derived knowledge. The trigger graph 400 is therefore used to guide the execution of the rules. Accordingly, the trigger graph 400 is a type of execution graph.

The trigger graph 400 comprises a plurality of nodes 401, wherein each of the nodes 401 is associated with one of the rules 312. For example, the trigger graph 400 comprises a first node 401a associated with rule 312a and a second node 401b associated with rule 312b. The trigger graph 400 also includes edges 402, which represent the operations required to execute the rule at a node. In other words, the edges represent which outputs of rules are used to execute which subsequent rules.

In FIG. 4, the graph 400 includes a first edge 402a, reflecting that a first piece of knowledge required to evaluate the rule p(X,Y) <- p(X,Z), p(Z,Y) is p(X,Z). The graph 400 includes a second edge 402a, reflecting that a second piece of knowledge required to evaluate the rule p(X,Y) <- p(X,Z), p(Z,Y) is p(Z,Y).

The processor 220 is configured to generate the trigger graph 400 incrementally. Accordingly, at a round k:
a trigger graph of depth k is constructed;
the rules associated with the nodes present in the trigger graph at depth k are executed;
the derivation history of the knowledge in the trigger graph is stored.

The derivation history make take the form of derivation trees, as will be discussed further below. The derivation history of a node may also be stored at the node.

At a round k+1, a trigger graph is constructed by taking the trigger graph constructed at k, adding nodes that reflect additional rules that are to be computed based on the rules of the trigger graph at round k, and executing the rules of the graph at depth k+1, and storing the derivation history.

The process continues to iterate in this manner, until a termination condition is met. The termination condition may be that a fact already derived by the process is derived for a second time. This indicates that no new knowledge is being inferred and so the process can cease.

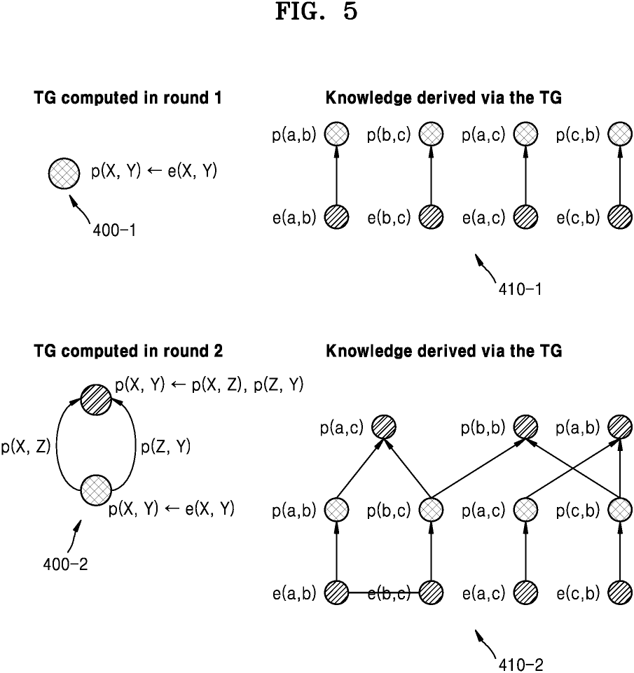

FIG. 5 illustrates an example of the technique for generation of the trigger graph 400 in more detail.

In round 1 of the process, a trigger graph 400-1 is created based on the first rule 312a. The rule 312a is then executed on the data present in the uncertain KB 311. This results in the generation of derivation history 410-1. The derivation history 410-1 reflects the execution of the rule 312a, i.e. that there are edges a -> b, b -> c, a -> c and c->b, and thus it can be derived that there are paths a -> b, b -> c, a -> c and c -> b. The derivation history 410-1 takes the form of derivation trees, each tree indicating how the new facts have been derived.

In round 2 of the process, a trigger graph 400-2 is created by adding a node to the trigger graph 400-1 representing the second rule 312b. The rule 312b is then executed on the data present in the uncertain KB 311. This results in the generation of derivation history 410-2. The derivation history 410-2 reflects the execution of the rule 312b, i.e. that there is a path a -> c because there are paths a -> b and b -> c, there is a path b -> b because there paths b -> c and c -> b, and there is a path a -> b because there are paths a -> c and c -> b.

As the fact path a -> b has already been derived in an earlier round, the process then terminates. The derivation history 410-2 is then used to compute the probabilities of the new facts. For example, the probability of p(b,b) is calculated from the probability of p(b,c) and p(c,b). The probability of p(b,c) and p(c,b) is in turn calculated from the probability of e(b,c) and e(c,b), which are present in the uncertain KB 311.

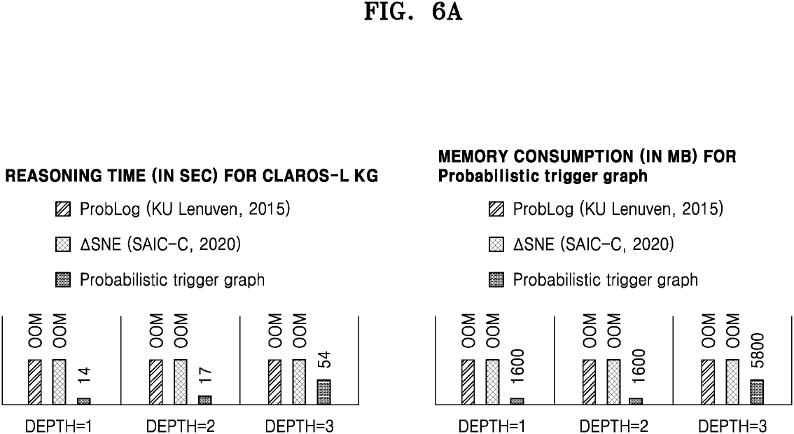

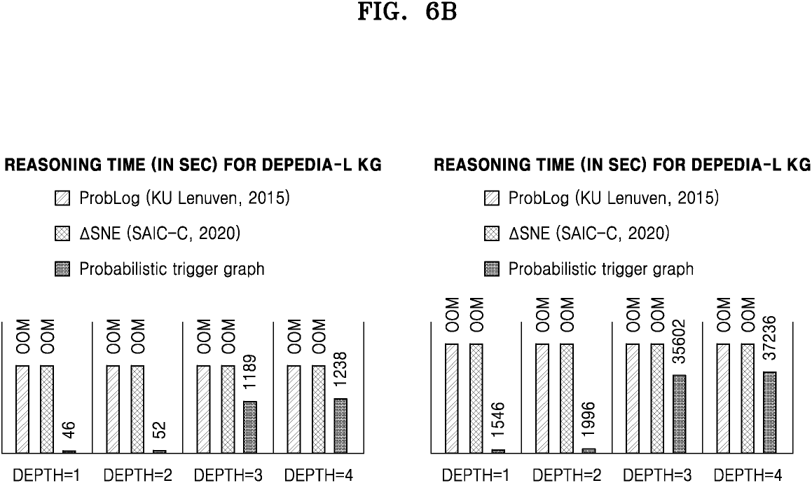

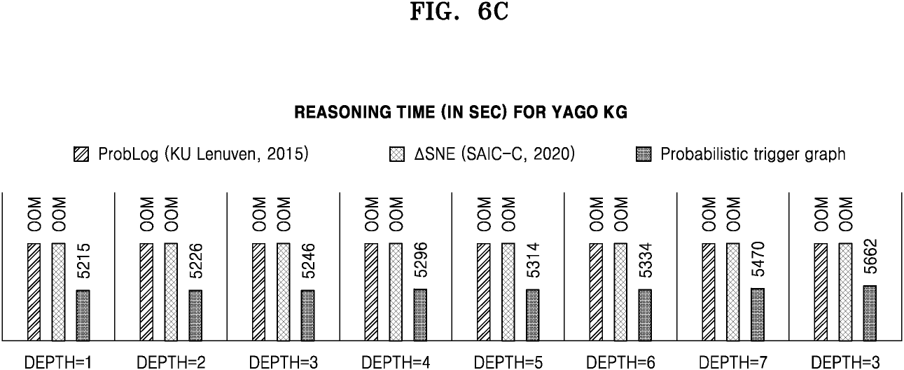

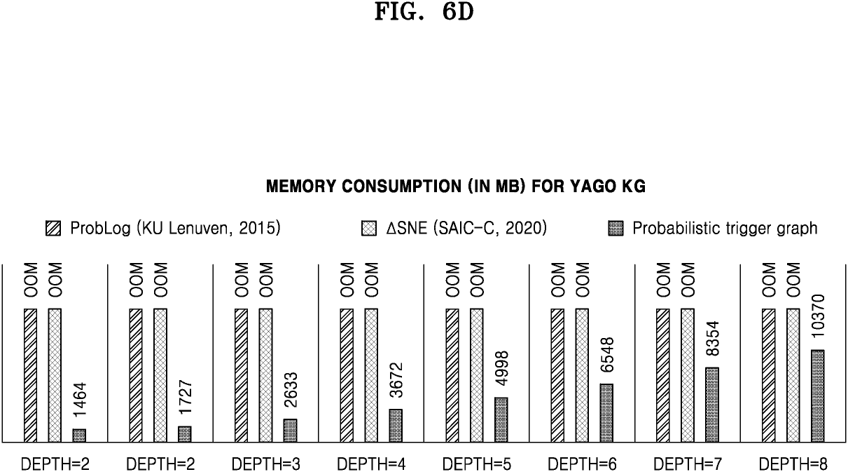

FIGS. 6A-D illustrate the results of empirical experiments comparing the performance of the present techniques (referred to as Probablistic Trigger Graph) with two previous techniques, ProbLog (discussed in Luc De Raedt, Angelika Kimmig, and Hannu Toivonen. 2007. ProbLog: A Probabilistic Prolog and Its Application in Link Discovery. In Proceedings of the 20th International Joint Conference on Artificial Intelligence. 2462-2467 and Jonas Vlasselaer, Guy Van den Broeck, Angelika Kimmig, Wannes Meert, and Luc De Raedt. 2016. TP-Compilation for inference in probabilistic logic programs. International Journal of Approximate Reasoning 78 (2016), 15 - 32) and ΔSNE (discussed in Efthymia Tsamoura, Victor Gutierrez-Basulto, and Angelika Kimmig. 2019. Beyond the Grounding Bottleneck: Datalog Techniques for Inference in Probabilistic Logic Programs. In AAAI, 2020.). FIG. 6A shows the time in seconds and memory consumption to compute the probabilistic model of CLAROS-L KG (13.8 M input triples, 2600 rules) at different depths. FIG. 6B shows the time (in seconds) and memory consumption (in MB) to compute the probabilistic model of DBPEDIA-L KG (29 M input triples, 9300 rules) at different depths. FIG. 6C shows the time (in seconds) to compute the probabilistic model of YAGO KG (18.2 M input triples, 498,000 rules) at different depths. FIG. 6D shows the Memory consumption (in MB) to compute the probabilistic model of YAGO KG (18.2 M input triples, 498,000 rules) at different depths. In each of FIGS. 6A-D, OOM stands for out of memory in a 100GB Linux machine.

As can be seen from FIGS. 6A-D, the present techniques reduce computation time and memory consumption associated with deriving new facts from different uncertain KBs.

In the examples discussed above, the trigger graph is generated using the whole of the uncertain KB 211. However, in further examples, it may be desirable to derive only the facts related to an input query. Accordingly, a part of the uncertain KB 211 may be extracted based on an input query, and the techniques discussed herein applied to the extracted part of the uncertain KB 211. In one example, a magic sets technique is applied to extract the relevant part of the uncertain KB 211. Magic sets are discussed in detail in the following publications, the contents of which are incorporated herein by reference:
Francois Bancilhon, David Maier, Yehoshua Sagiv, and Jeffrey D. Ullman. 1985. Magic sets and other strange ways to implement logic programs. In PODS. ACM, 1-15;
Catriel Beeri, Raghu Ramakrishnan, On the power of magic, The Journal of Logic Programming, Volume 10, Issues 3-4, 1991, Pages 255-299;
Michael Benedikt, Boris Motik, and Efthymia Tsamoura. 2018. Goal-Driven Query Answering for Existential Rules With Equality. In AAAI. AAAI Press. 1761-1770.

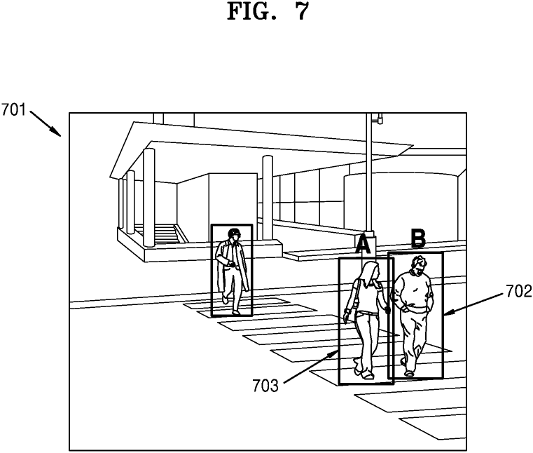

FIG. 7 illustrates an example application of the present techniques. Particularly, FIG. 7 illustrates application of the present techniques to group activity detection from images. In the example of FIG. 7, a machine learning system such as a DNN has been trained to identify a person carrying out an activity. The present techniques allow the detection of group activities by inference based on the detection of individual activities.

Particularly, the probabilistic facts may be the likelihood that a first person 702 detected in an image 701 is carrying out an activity. The rules may comprise rules for determining whether a second person 703 detected in an image is also carrying out the activity. The derived new facts may include the likelihood that the second person 703 detected in the image 701 is also carrying out the activity.

DNN outputs likelihood B to be the first person 702 walking (DOING(B, walking)).

CLOSE(A,B) measures degree A and B are close in the image.

For example, the following set of rules may be specified:
(R1) DOING(B, a) ← LOCAL(B, a)
(R2) DOING(B, a) ← FRAME(B, F) ∧ FRAMELABEL(F, a)
(R3) DOING(B2, a) ← CLOSE(B1, B2) ∧ DOING(B1, a)
(R4) SAME(B1, B2) ← SEQ(B1, B2) ∧ CLOSE(B1, B2)
(R5) DOING(B2, a) ← SAME(B1, B2) ∧ DOING(B1, a)

In this example, R1 corresponds to beliefs about local predictions. R2 expresses the belief that if many actors in the current frame are doing a particular action, then perhaps everyone is doing that action. The FRAMELABEL predicate accumulates the LOCAL activity beliefs for all actors in the frame. R3 enforces the effect of proximity on activity, where actors that are close in the same frame are likely to perform the same action. R4 is used for identity maintenance and tracking. It says that if two bounding boxes occur in adjacent frames and their positions have not changed significantly, then they are likely the same actor. We then reason, in R5, that if two bounding boxes (in adjacent frames) refer to the same actor, then they are likely to be doing the same activity.

Low-level features (i.e. the machine learning system) are used to infer that bounding box B shows a person 702 walking with a particular likelihood. Then, Rule DOING(A, walking) ← CLOSE(A,B) ∧ DOING(B, walking) derives the likelihood A to also be a person 703 walking.

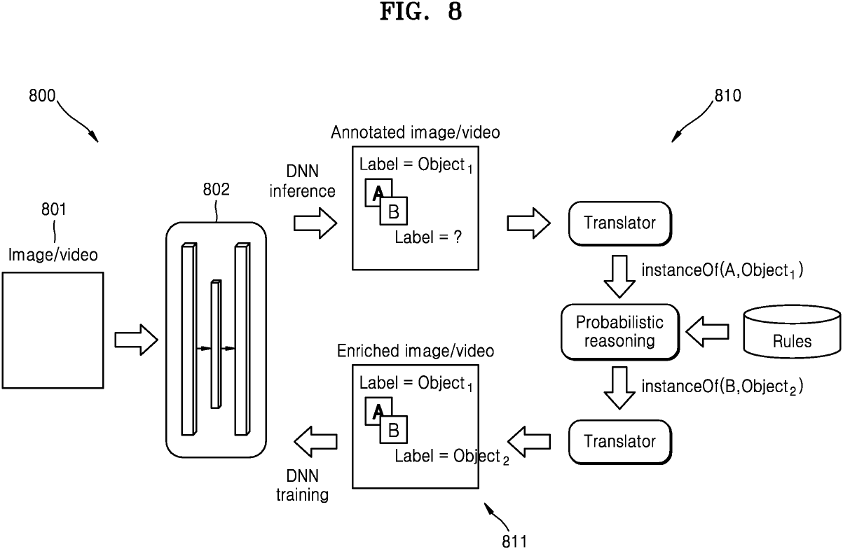

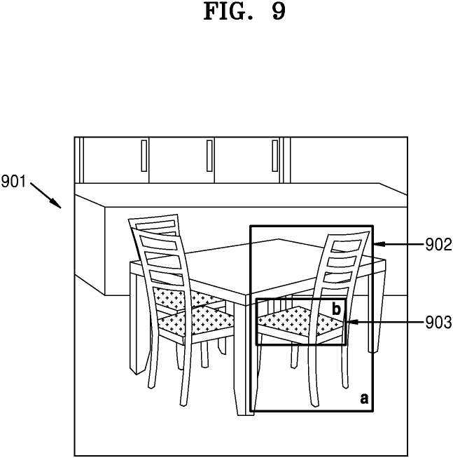

FIGS. 8 and 9 illustrates another example of the present techniques. In the example of FIGS. 8 and 9, the present techniques are used to generate labelled training data for a machine learning system such as a DNN.

FIG. 8 shows an outline of a semi-supervised learning system 800. The system receives an input image 801. A machine learning technique such as a DNN 802 is used to detect a first object A in the input image 801, and provide a likelihood that the first object A detected in an image has a first label. The DNN 802 may also detect a second object B in the input image, wherein the label for the second object B is unknown.

The present techniques are then applied in the part of the system generally indicated by the reference numeral 810. The labels and likelihoods for object A form the probabilistic facts of the system 800. The rules comprise rules for inferring that the second object B detected in the image has a second label. The derived new facts may include the likelihood that the second object has the second label.

Accordingly, a label is generated for object B, as shown in image 811, along with a probability for the label. The newly-labelled image 811 can then be used in training the DNN 802. The newly-labelled image 811 may be used if the probability for the label exceeds a threshold, so that only labels that have a high likelihood of being accurate are used in further training.

FIG. 9 further illustrates the system of FIG. 8. In the example of FIG. 9, the input image 901 includes a bounding box 902 indicating a chair detected in the image. The bounding box 903 indicates another object that is a sub-object of the chair that has been detected.

The probabilistic program associated with this scenario may comprise the facts 0.85::chair(a) and 1.00::partOf(b,a). In other words, there is a probability of 0.85 that the detected object 902 is a chair, and a probability of 1 that the second object 903 is a part of the chair 902. The probabilistic program may also comprise the rule cushion(Y) ←chair(X), partOf(Y,X). Accordingly, the 800 system may then infer that the correct label for the object 903 is cushion. The resulting label can then be used as further training data.

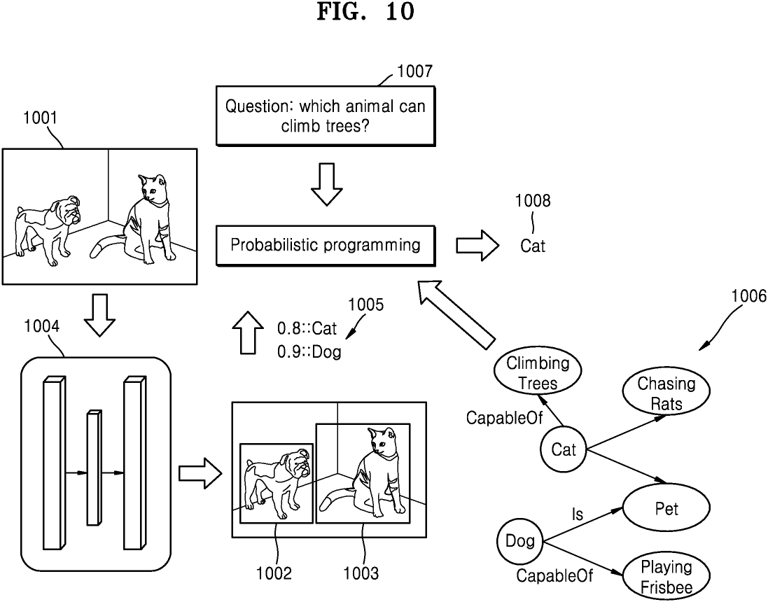

FIG. 10 illustrates another example application. In the example of FIG. 10, an input image 1001 is received and objects 1002, 1003 are detected and labelled in the image by a machine learning system 1004. The confidence of the labels forms the probabilistic facts 1005 of the probabilistic program. Rules 1006, for example from a commonsense KB, provide information about the detected objects 1002, 1003. Accordingly, in response to a user query 1007, an answer 1008 can be provided by executing the probabilistic program as discussed herein. It will be appreciated that the present techniques are equally applicable to question answering that does not include a visual aspect.

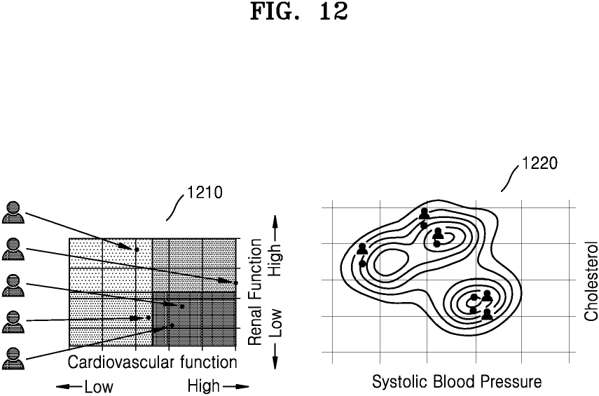

FIG. 12 illustrates another example application. In the example of FIG. 12, the present techniques are applied to problems relating to phenotyping in healthcare. For example, the techniques may be applied to phenotypic matching 1210, where phenotypes are explicitly defined, and the goal is to map noisy data sources into these labels. Alternatively, the goal may be uncovering latent phenotypes 1220, where there is uncertainty about what phenotypic definitions should be, and the goal is to identify useful characterizations that could impact patient care.

Both phenotypic matching 1210 and uncovering latent phenotypes 1220 are visualized in FIG. 12. In a further alternative, the present techniques may be applied to semi-supervised phenotyping, which is a hybrid approach that straddles matching and discovery, where we assume that some label information is available, e.g., with the use of specific “anchoring” clinical terms.

In the example of FIG. 12, Phenotyping matching 1210 matches patients x with explicitly defined phenotypes, here described in different shades as having high/low cardiovascular function and high/ low renal function. Uncovering latent phenotypes 1220 learns new phenotypes to identify useful characterization through probabilistic clustering.

Probabilistic phenotyping is discussed in more detail in Chen IY, Joshi S, Ghassemi M, Ranganath R. Probabilistic Machine Learning for Healthcare. Annu Rev Biomed Data Sci. 2021 Jul 20, the contents of which are incorporated herein by reference.

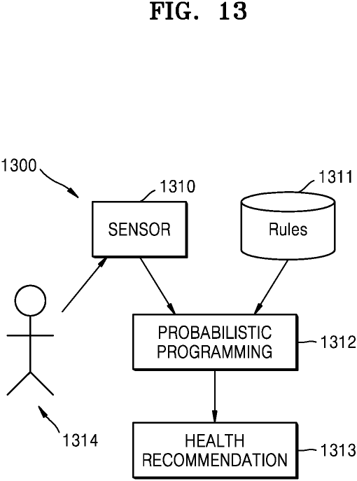

FIG. 13 illustrates another example application. In the example of FIG. 13, a system 1300 includes a sensor 1310, medical rules 1311, and a probabilistic programming module 1312 which makes use of the present techniques. The sensor 1310 is able to measure healthcare or wellbeing related data of a user 1314. For example, the sensor 1310 may comprise a blood pressure sensor, heart rate sensor, a sensor measuring exercise carried out by the user (e.g. distance walked) are applied to healthcare. These measurements form the probabilistic facts of the system 1300, in that the sensor readings may have a degree of confidence associated therewith. Instead of or in addition to sensor data from sensor 1310, the probabilistic facts may comprise data from other sources related to the wellbeing or health of the user, such as information about food eaten from a food diary. The rules 1311 may comprise rules for providing recommendations as to appropriate exercise, diet, or other such lifestyle recommendations. An example rule could be “avoid eating salty food if you have a high blood pressure”. In some examples, the rules may be mined from medical texts by machine learning. Accordingly, the probabilistic programming module 1312 may provide a suitable health recommendation 1313, by carrying out inference over the rules and probabilistic facts.

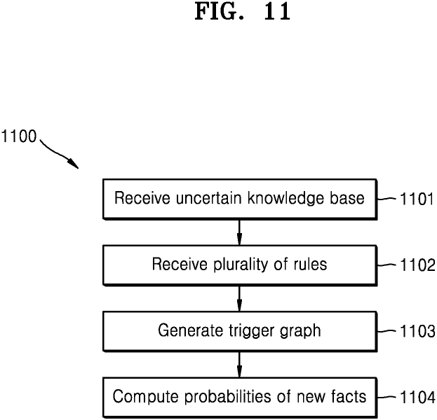

FIG. 11 is a flowchart of an example method 1100, which may for example be carried out by the system 200. In block 1101, the method receives an uncertain knowledge base, the uncertain knowledge base comprising a plurality of probabilistic facts, each probabilistic fact having an associated probability. In block 1102, the method receives a plurality of rules, the plurality of rules for deriving new facts from the plurality of probabilistic facts. In block 1103, the method generates a trigger graph from the uncertain knowledge base, wherein each node of the trigger graph is associated with a rule of the plurality of rules, and wherein each node of the trigger graph stores a derivation history of the node. In block 1104, the method computes probabilities of derived new facts using the derivation histories stored in the trigger graph. The method may comprise further steps, as discussed herein.

The systems and methods described herein may allow the development of applications using “simpler” components (e.g., deep networks that perform easier tasks and hence they are easier to train) as building blocks. Rules can then complete the deep network predictions or the sensor observations using domain specific knowledge. The systems and methods described herein may conveniently generate labels for partially-labelled data, facilitating semi-supervised learning and avoiding the time and cost of manual annotation. The systems and method described herein may also facilitate question answering.

Those skilled in the art will appreciate that while the foregoing has described what is considered to be the best mode and where appropriate other modes of performing present techniques, the present techniques should not be limited to the specific configurations and methods disclosed in this description of the preferred embodiment. Those skilled in the art will recognise that present techniques have a broad range of applications, and that the embodiments may take a wide range of modifications without departing from any inventive concept as defined in the appended claims.

What is claimed is:

1. A computer-implemented method for executing a probabilistic program comprising:
receiving an uncertain knowledge base, the uncertain knowledge base comprising a plurality of probabilistic facts, each probabilistic fact having an associated probability;
receiving a plurality of rules, the plurality of rules for deriving new facts from the plurality of probabilistic facts;
generating a trigger graph from the uncertain knowledge base, wherein each node of the trigger graph is associated with a rule of the plurality of rules, and wherein each node of the trigger graph stores a derivation history of the node; and
computing probabilities of derived new facts using the derivation histories stored in the trigger graph.

2. The method of claim 1, comprising generating the trigger graph incrementally by, wherein in a round k of generating the trigger graph:
a trigger graph of depth k is constructed by adding nodes to a trigger graph of round k-1;
the rules associated with the nodes present in the trigger graph at depth k are executed, and
the derivation history of the knowledge in the trigger graph at depth k is stored.

3. The method of claim 1, wherein the uncertain knowledge base is a graph knowledge base, wherein the probabilistic facts are relationships represented by edges linking nodes representing entities, and the associated probability is a weight of an edge.

4. The method of claim 1, wherein:
a probabilistic fact of the probabilistic facts comprises a likelihood that a first person detected in an image is carrying out an activity;
the rules comprise rules for determining whether a second person detected in an image is also carrying out the activity; and
the derived new facts include the likelihood that the second person detected in the image is also carrying out the activity.

5. The method of claim 1, wherein:
a probabilistic fact of the probabilistic facts comprises a likelihood that a first object detected in an image has a first label;
the rules comprise rules for determining that a second object detected in the image has a second label; and
the derived new facts include the likelihood that the second object has the second label.

6. The method of claim 1, comprising:
receiving a user query, and
providing an answer the query based on the derived new facts.

7. The method of claim 6, comprising selecting a part of the uncertain knowledge base relevant to the user query, and generating the trigger graph based on the selected part of the uncertain knowledge base.

8. The method of claim 6, wherein the user query and the answer relate to an input image.

9. A system for executing a probabilistic program, comprising:
at least one memory configured to store:
an uncertain knowledge base, the uncertain knowledge base comprising a plurality of probabilistic facts, each probabilistic fact having an associated probability, and
a plurality of rules, the plurality of rules for deriving new facts from the plurality of probabilistic facts; and
at least one processor coupled to the memory and arranged to:
generate a trigger graph from the uncertain knowledge base, wherein each node of the trigger graph is associated with a rule of the plurality of rules, and wherein each node of the trigger graph stores a derivation history of the node; and
compute probabilities of derived new facts using the derivation histories stored in the trigger graph.

10. The system of claim 9, wherein, comprising generating the trigger graph incrementally by, wherein in a round k of generating the trigger graph:
a trigger graph of depth k is constructed by adding nodes to a trigger graph of round k-1;
the rules associated with the nodes present in the trigger graph at depth k are executed, and
the derivation history of the knowledge in the trigger graph at depth k is stored.

11. The system of claim 9, wherein the uncertain knowledge base is a graph knowledge base, wherein the probabilistic facts are relationships represented by edges linking nodes representing entities, and the associated probability is a weight of an edge.

12. The system of claim 9, wherein, the at least one processor is configured to:
a probabilistic fact of the probabilistic facts comprises a likelihood that a first person detected in an image is carrying out an activity;
the rules comprise rules for determining whether a second person detected in an image is also carrying out the activity; and
the derived new facts include the likelihood that the second person detected in the image is also carrying out the activity.

13. The system of claim 9, wherein:
a probabilistic fact of the probabilistic facts comprises a likelihood that a first object detected in an image has a first label;
the rules comprise rules for determining that a second object detected in the image has a second label; and
the derived new facts include the likelihood that the second object has the second label.

14. The system of claim 9, wherein, the at least one processor configured to:
receive a user query; and
provide an answer the query based on the derived new facts.

15. The system of claim 14, comprising selecting a part of the uncertain knowledge base relevant to the user query, and generating the trigger graph based on the selected part of the uncertain knowledge base.

16. The system of claim 14, wherein the user query and the answer relate to an input image.

17. A non-transitory data carrier carrying code which, when implemented on at least one processor, causes the processor of a system for executing a probabilistic program to:
receive an uncertain knowledge base, the uncertain knowledge base comprising a plurality of probabilistic facts, each probabilistic fact having an associated probability;
receive a plurality of rules, the plurality of rules for deriving new facts from the plurality of probabilistic facts;
generate a trigger graph from the uncertain knowledge base, wherein each node of the trigger graph is associated with a rule of the plurality of rules, and wherein each node of the trigger graph stores a derivation history of the node; and
compute probabilities of derived new facts using the derivation histories stored in the trigger graph.

18. The non-transitory data carrier of claim 17, comprising generating the trigger graph incrementally by, wherein in a round k of generating the trigger graph:
a trigger graph of depth k is constructed by adding nodes to a trigger graph of round k-1;
the rules associated with the nodes present in the trigger graph at depth k are executed, and
the derivation history of the knowledge in the trigger graph at depth k is stored.

19. The non-transitory data carrier of claim 17, wherein the uncertain knowledge base is a graph knowledge base, wherein the probabilistic facts are relationships represented by edges linking nodes representing entities, and the associated probability is a weight of an edge.

20. The non-transitory data carrier of claim 17, wherein:
a probabilistic fact of the probabilistic facts comprises a likelihood that a first person detected in an image is carrying out an activity;
the rules comprise rules for determining whether a second person detected in an image is also carrying out the activity; and
the derived new facts include the likelihood that the second person detected in the image is also carrying out the activity.
